(19) United States
(12) Patent Application Publication
(10) Pub. No.: US 2024/0220840 A1
(43) Pub. Date: Jul. 4, 2024

(54) QUANTUM CHIP OPTOELECTRONIC INTERPOSER

(71) Applicant: UNIVERSITY OF SOUTHERN CALIFORNIA, Los Angeles, CA (US)

(72) Inventors: Ajey Poovannummoottil JACOB, Los Angeles, CA (US); Akhilesh Ramlaut JAISWAL, Los Angeles, CA (US); Ramesh KUDALIPPALLIYALIL, Los Angeles, CA (US)

(73) Assignee: UNIVERSITY OF SOUTHERN CALIFORNIA, Los Angeles, CA (US)

(21) Appl. No.: 18/684,145

(22) PCT Filed: Aug. 16, 2022
(86) PCT No.: PCT/US2022/040471

§ 371 Date: Feb. 15, 2024

Related U.S. Application Data
(60) Provisional application No. 63/233,485, filed on Aug. 16, 2021.

(51) Int. Cl. G06N 10/40

(52) U.S. Cl. CPC G06N 10/40

(57) ABSTRACT

A heterogeneous quantum device includes an interposer, a qubit sources disposed over the interposer, and an electro-optic quantum transducer disposed over the interposer. The electro-optic quantum transducer being a frequency converter that converts microwave frequency to optical frequency coupled to the qubit sources by superconducting capacitive or inductive coupling.

### CROSS-REFERENCE TO RELATED APPLICATIONS

This application claims the benefit of U.S. provisional application Ser. No. 63/233,485 filed Aug. 16, 2021, the disclosure of which is hereby incorporated in its entirety by reference herein.

### STATEMENT REGARDING FEDERALLY SPONSORED RESEARCH OR DEVELOPMENT

The invention was made with Government support under Contract No. 5345403374 awarded by the National Science Foundation (NSF). The Government has certain rights to the invention.

### TECHNICAL FIELD

In at least one aspect, the present invention relates to a quantum chip optoelectronic interposer.

### BACKGROUND

The commercially available quantum computers are either based on superconducting electronics or trapped ions or pho-tonics. Among them, Josephson Junctions-based superconducting quantum (SCQ) technology is a promising candidate for scalable quantum computing because of its strong coupling to microwave signals. However, their limitation is the short coherence lifetime. A fault-tolerant quantum computer architecture demands integrating several qubits with optimized signal routing and control electronics without sacrificing the quantum coherence [1], [2]. Classical interconnects are of large footprint and demand high cooling power. It also undermines the coherency of quantum states by coupling disruptive noises from the environment back into qubits. Moreover, monolithic integration of such devices is challenging due to the material, and thermodynamic incompatibilities of different quantum components and their increased parasitic modes [3][4][5]-[6]. Therefore, a heterogeneously integrated scalable interposer packaging architecture with directional quantum interlink is of great importance to merge and interconnect various functionalities within a sophisticated chip while maintaining qubit coherence. A quantum chip interposer provides tremendous value to the interconnect ecosystem as it helps to provide (1) optimized power, performance, and area benefits, (2) mechanical stability, (3) ease of integrating better thermal dissipating materials through integration architecture optimizations, (4) integrate multiple power/voltage domains, and (5) can handle fully functional and versatile test capability. There have been a few efforts recently reported on the interposer level packaging of superconducting qubits [7] and the ion trap qubits [8]. The former, is an electrical interposer architecture and mainly focused on the 3D signal routing and packaging of qubits in cryogenics but is not designed to integrate other types of physical qubits, quantum transducer, quantum memory, quantum circulators, etc. Moreover, these electrical interposers cater to superconducting qubits embedded microwave signals and have limitations in transferring data between the chips (chip-to-chip communication) or from the cryogenic world to the non-cryogenic world. The latter is an optical interposer with bulky optical components which is designed to support only the ion trap qubits and their control/readout optical waveguides.

High fidelity transfer of quantum signals in a non-cryogenic environment is the key bottleneck for networking different quantum computers. For these kinds of inter-system connections, quantum converters are needed [9], [10]. For example, superconducting qubits are among the most promising and scalable candidates for implementing nodes in a quantum computing network, and their operation is restricted to cryogenic temperature and microwave frequencies. To coherently exchange quantum states to a different platform will require converting quantum information from microwave to other frequencies, such as optical photons, at which trapped ion/atom systems are operated. Thus, an essential capability for the networking and development of quantum technology is the interconversion of quantum information between the optical and microwave frequency domains. Recently, Lecocq et al. [11], demonstrated a photonic link-based approach to control and readout the superconducting qubits. In this method, a room-temperature microwave signal is electro-optically modulated to the optical domain and routed via optical fibers to the high-speed photodetectors which is integrated with the quantum circuits in the dilution refrigerator.

Accordingly, there is a need for improved heterogeneous quantum devices and methods for their fabrication.

### SUMMARY

In at least one aspect, a heterogeneous quantum device is provided. The heterogeneous quantum device includes an interposer, a qubit source(s) disposed over the interposer, and an electro-optic quantum transducer disposed over the interposer. The electro-optic quantum transducer is a frequency converter that converts microwave frequency to optical frequency coupled to the qubit sources by superconducting capacitive or inductive coupling.

In another aspect, a heterogeneous quantum device is provided. The heterogeneous quantum device includes a plurality of quantum sources, a plurality of quantum frequency converters, a plurality of quantum sensors, and a plurality of quantum memory devices interconnected through electrical or photonics multilevel interconnects on the same interposer platform.

In another aspect, a heterogeneous quantum device is provided. The heterogeneous quantum device includes an interposer, a superconducting qubit source, superconducting microwave resonators coupled to the superconducting qubit source by superconducting capacitive or inductive coupling, a microwave-to-optical transducer for optical photon conversion, and edge couplers in optical communication with the optical transducer.

In another aspect, a heterogeneous quantum device is provided. The heterogeneous quantum device includes an interposer defining a plurality of through silicon vias therethrough, the interposer having a top face and a bottom face, a top metal layer disposed over the top face, a qubit circulator positioned on the top face of the interposer, and a transducer chip integrated (e.g., disposed over) over the top face of the interposer. The transducer chip includes a microwave resonator, an optical microdisk resonator cavity, optical waveguides, and an edge coupler forming an electro-optic microwave to optical frequency converter The edge coupler is configured to attach the optical waveguides to an input/output fiber in the V-grooves. The heterogeneous quantum device also includes a superconducting qubit chip disposed over the top face of the interposer, the superconducting qubit chip including qubit sources, microwave circuits positioned on the top face of the interposer, and a superconducting redistribution module disposed over the bottom face of the interposer

In another aspect, hybrid 2D (In-plane/horizontal) integration of heterogeneous quantum devices (e.g., memory, sensors, detectors, circulators, qubit sources) is provided.

In another aspect, hybrid 3D (non-planar/vertical) integration of heterogeneous quantum devices (e.g., memory, sensors, detectors, circulators, qubit sources) is provided.

In another aspect, structures and methods of integrating an edge coupler-fiber interconnect solution for cryogenic interposer technology is provided.

In another aspect, structures and methods of forming chip to chip quantum photonics and electrical interconnect for cryogenic interposer technology is provided.

In another aspect, the heterogeneous quantum device includes a microwave resonator formed by aligning capacitive electrodes and resonator cavities.

In another aspect, the capacitive electrodes are disposed on a first chip that includes the qubit sources.

In another aspect, qubit sources are biased with electrodes electrically communicating with circuitry on a bottom face of the interposer by vias extending through the interposer.

In another aspect, the heterogeneous quantum device includes edge couplers in optical communication with electro-optic quantum transducer.

In another aspect, the heterogeneous quantum device includes a plurality of quantum sources are selected from the group consisting of superconducting Josephson Junction qubit, single photon quantum dot qubits, trapped ion qubits, NV center qubits, and combinations thereof.

In another aspect, the heterogeneous quantum device includes a plurality of quantum frequency converters are selected from the group consisting of opto-electromechanical, piezo-opto-mechanical, opto-mechanical, electro-optical, optomagnonics, and combinations thereof.

In another aspect, the interposer is composed of silicon or sapphire.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Cross section of a quantum chip universal interposer. Conceptual integration scheme of electronic and photonic quantum components in a heterogeneous packaging

FIGS. 2A, 2B, and 2C. Schematics of a heterogeneous quantum device are provided. (A) 3D schematic and (B) 2D cross section of a QuIP, (C) illustration of inductive coupling between qubit chip and transducer chip (the dotted rectangle region in (B)).

FIG. 2D. Flowchart for a method for forming the optical chip optical interposer of FIGS. 1A and 1B.

FIGS. 3A, 3B, 3C-1, and 3C-2. (A) 3D schematic of an EO frequency transducer based on coupled micro-disk resonators, (B) optical through port transmission characteristics of the EO transducer, (C) microwave resonance characteristics of the superconducting resonator integrated on top of the AlN disk resonators and coupled inductively to the microwave feed line on the qubit chip.

FIGS. 4A and 4B. Schematic (A) 3D view and (B) cross-section of a backside optical coupling (BOC) compatible with QuIP.

FIG. 5. Schematic flowchart showing the integration process flow for the QuIP. The edge coupling scheme is shown for illustration. (1) Interposer material (Si), (2) recessed region and V-groove fabrication, (3) TSV fabrication, (4) patterning of microwave circuits on the interposer, (5) transducer chip bonding, (7) bonding of SC qubit chip, circulator chip, etc., (8) fiber coupling and alignment.

FIG. 6. Schematic of a heterogeneous quantum device having a 3D integrated quantum chip optical interposer chip on Si, vertical inter-chip inductive coupling of microwave field between qubit chip and frequency converter, and heterogeneous thin film bonding of optical chip with superconducting resonators (chip 2) on the interposer.

FIG. 7. Schematic of a heterogeneous quantum device having a 3D integrated quantum chip optical interposer chip on Si, In-plane inter-chip inductive coupling of microwave field between flip-chip bonded qubit chip and frequency converter, and heterogeneous thin film bonding of optical chip with superconducting resonators (chip 2) on the interposer.

FIG. 8. Schematic of a heterogeneous quantum device having a 3D integrated quantum chip optical interposer chip on Si and heterogeneous thin film bonding of optical chip (chip 2) on the interposer.

FIG. 9. Schematic of a heterogeneous quantum device having a 3D integrated quantum chip optical interposer chip on Si, in-plane inter-chip inductive coupling of microwave field between qubit chip on the interposer and the frequency converter (Josephson Junction is monolithically integrated on the interposer), and heterogeneous thin film bonding of optical chip with superconducting resonators (chip 2) on the interposer.

FIG. 10. Schematic of a heterogeneous quantum device having a 3D integrated quantum chip optical interposer chip on Si, flip-chip bonding optical resonator chip over the microwave resonators (all microwave circuits are monolithically integrated on to the interposer and optical chip is separately bonded and integrated), and thin film flip chip bonding of optical chip (chip 2) with the interposer.

FIG. 11. Schematic of a heterogeneous quantum device having 3D integrated quantum chip optical interposer chip on Si, vertical inter-chip inductive coupling of microwave field between qubit chip (monolithically integrated on to the interposer) and frequency converter, and fiber coupling is to the optical chip that is bonded on the interposer.

FIG. 12. Schematic of a heterogeneous quantum device having a 3D integrated quantum chip optical interposer chip on Si, vertical inter-chip inductive coupling of microwave field between qubit chip and frequency converter, and butt coupling/evanescent field coupling between interposer waveguide and chip2 waveguides (Fiber coupling is to the interposer waveguide).

FIG. 13. Schematic of a heterogeneous quantum device having a 3D integrated quantum chip optical interposer chip on Si, in-plane inter-chip inductive coupling of microwave field between qubit chip and frequency converter, and butt coupling/evanescent field coupling between interposer waveguide and chip2 waveguides.

FIG. 14. Schematic of a heterogeneous quantum device having a 3D integrated quantum chip optical interposer chip on Si, heterogeneous thin film bonding of optical chip (chip 2) on the interposer and butt coupling/evanescent field coupling between interposer waveguide and chip2 waveguides.

FIG. 15. Schematic of a heterogeneous quantum device having a 3D integrated quantum chip optical interposer chip on Si, in-plane inter-chip inductive coupling of microwave field between qubit chip and frequency converter, heterogeneous thin film bonding of optical chip (chip 2) on the interposer, and butt coupling/evanescent field coupling between interposer waveguide and chip2 waveguides.

FIG. 16. Schematic of a heterogeneous quantum device having a 3D integrated quantum chip optical interposer chip on Si, flip-chip bonding optical resonator chip over the microwave resonators, thin film flip chip bonding of optical chip (chip 2) with the interposer, and butt coupling/evanescent field coupling between interposer waveguide and chip2 waveguides.

FIG. 17. Schematic of a heterogeneous quantum device having a 3D integrated quantum chip optical interposer chip on Si, vertical inter-chip inductive coupling of microwave field between qubit chip and frequency converter, heterogeneous thin film flip-chip bonding of optical chip with superconducting resonators (chip 2) on the interposer, and butt coupling/evanescent field coupling between interposer waveguide and chip 2 waveguides.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1, to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For any device described herein, linear dimensions and angles can be constructed with plus or minus 50 percent of the values indicated rounded to or truncated to two significant figures of the value provided in the examples. In a refinement, linear dimensions and angles can be constructed with plus or minus 30 percent of the values indicated rounded to or truncated to two significant figures of the value provided in the examples. In another refinement, linear dimensions and angles can be constructed with plus or minus 10 percent of the values indicated rounded to or truncated to two significant figures of the value provided in the examples.

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The terms “DC signal” refer to electrical signals that do not materially vary with time over a predefined time interval. In this regard, the signal is DC over the predefined interval. “DC signal” includes DC outputs from electrical devices and DC inputs to devices.

The terms “AC signal” refer to electrical signals that vary with time over the predefined time interval set forth above for the DC signal. In this regard, the signal is AC over the predefined interval. “AC signal” includes AC outputs from electrical devices and AC inputs to devices.

It should also be appreciated that any given signal that has a non-zero average value for voltage or current includes a DC signal (that may have been or is combined with an AC signal). Therefore, for such a signal, the term “DC” refers to the component not varying with time and the term “AC” refers to the time-varying component. Appropriate filtering can be used to recover the AC signal or the DC signal.

The term “electronic component” refers is any physical entity in an electronic device or system used to affect electron states, electron flow, or the electric fields associated with the electrons. Examples of electronic components include, but are not limited to, capacitors, inductors, resistors, thyristors, diodes, transistors, etc. Electronic components can be passive or active.

The term “electronic device” or “system” refers to a physical entity formed from one or more electronic components to perform a predetermined function on an electrical signal.

The term “multiple” is synonymous with “plurality.”

In a refinement, the term “disposed over” means “integrated over.”

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

Throughout this application, where publications are referenced, the disclosures of these publications in their entireties are hereby incorporated by reference into this application to more fully describe the state of the art to which this invention pertains.

### Abbreviations

“BEOL” means back-end-of-line.

“FEOL” means front-end-of-line.

“TSV” means through-silicon via.

“QuIP” means quantum chip optoelectronics interposer.

“SCQ” means superconducting Quibit.

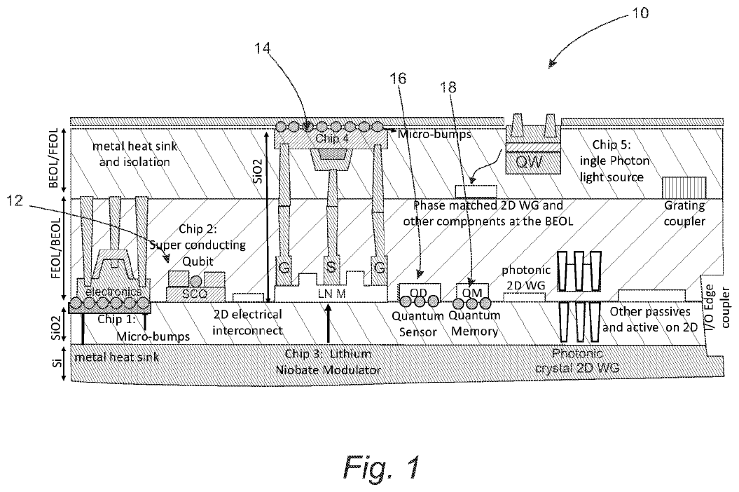

In at least one aspect, an interposer level packaging scheme (referred to as a quantum chip optoelectronic interposer (QuIP)) for the heterogeneous integration of electrical and optical quantum components with high fidelity directional quantum links is provided. FIG. 1 shows a 2D schematic of a QuIP. The QuIP is analogous to integrating a multi-chip module and system-on-a-chip hardware in the classical world [12]. In a refinement, the quantum bit interposer will interconnect between two similar or dissimilar quantum bit sources to form (1) an entangled pair or (2) between a quantum logic unit and a quantum memory unit to store an entangled pair or (3) between a logic unit and a sensor/detector. The quantum chip interposer can also have cryogenic electronic chips to enhance/augment the functions of the quantum chips. As an example, a quantum chip interposer will act as an interconnect between (1) two superconducting quantum bits or (2) two trapped-ion qubits or (3) two P-center qubits or (4) two different quantum bit sources and (5) their associated passive and active components to enhance the functions. The advantage of a quantum bit interposer is that the layout of the interposer's components can be made optimal for its power, performance, and area scaling factors. Thus, the QuIP can be an interface for short-reach or long-reach interconnects. The short reach interconnect will be electrical, and long reach will be optical for data density and power optimization.

The QuIP can improve qubit performance, provide controlled coupling between qubit devices, reduce cross-talk between qubit devices, improve thermal isolation, low microwave loss, and/or substrate mode suppression. The QuIP could also be designed to minimize electromagnetic field leakage. The module architecture can be designed to provide multi-qubit 3-dimensional quantum architectures with individual functional chips in each of the optimum layers. The electronic ICs used for driving the microwave energy to the superconducting chips can be integrated heterogeneously as a flip-chip on another layer with superconducting vias connecting the circuits. The same/dummy vias can also act as heat sinks for signal lines. The same VIA architecture can also be designed to shield quantum circuit from microwaves, for coupling between quantum circuits in different layers and/or for suppressing substrate noise. The interposer can also feature substrates with quantum circuit devices with one operating frequency disposed on a portion of the first surface of the substrate, electrically conducting vias extending through the substrate from the first surface to the second surface, and an electrically conducting [13].

More importantly, the interposer has chiral (unidirectional) links using topological materials or meta-materials that will allow the quantum signals to propagate in a single direction to minimize cross-talks while suppressing environmental disturbances from peripheral control and readout circuitry. This will improve scalability, coherency, and integrability.

Still referring to FIG. 1, heterogeneous quantum device 10 includes multiple quantum sources 12 (e.g., superconducting Josephson Junction qubit, single photon quantum dot qubits, trapped ion qubits, NV center qubits, etc.), multiple quantum frequency converters 14 (opto-electromechanical, piezo-opto-mechanical, opto-mechanical, electro-optical, opto-magnonics, etc.), multiple quantum sensors 16, and multiple quantum memory devices 18 which are interconnected through electrical or photonics multilevel interconnects on the same interposer platform.

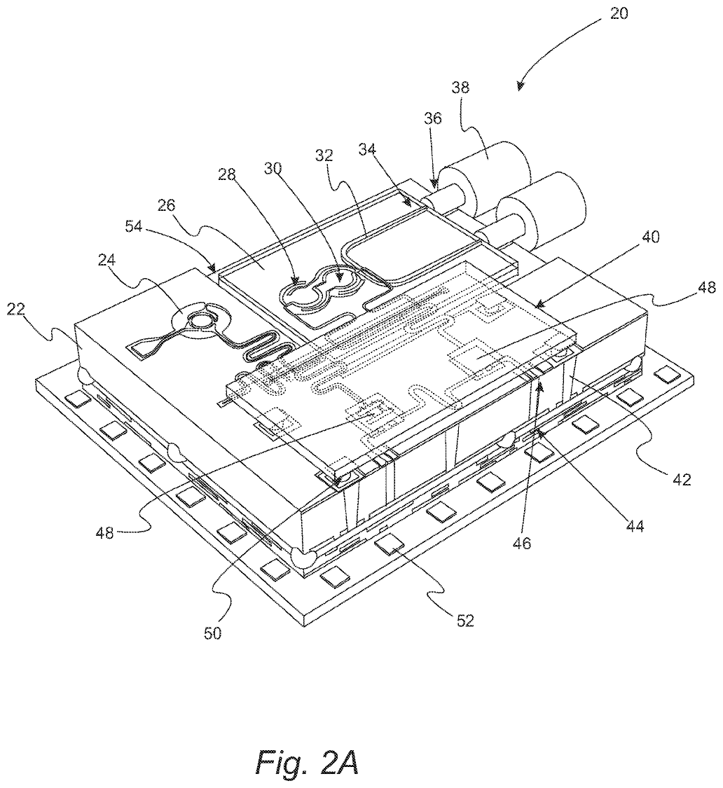

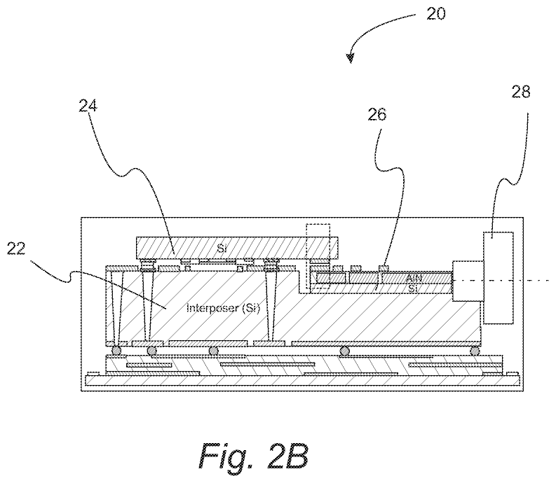

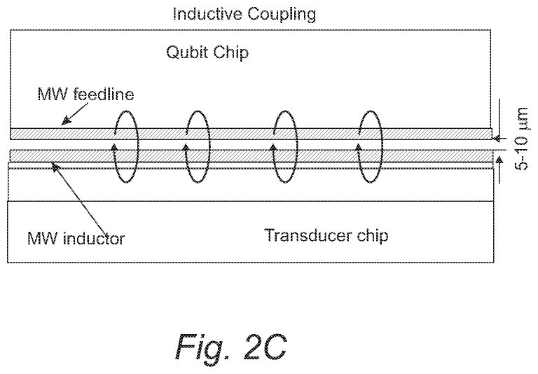

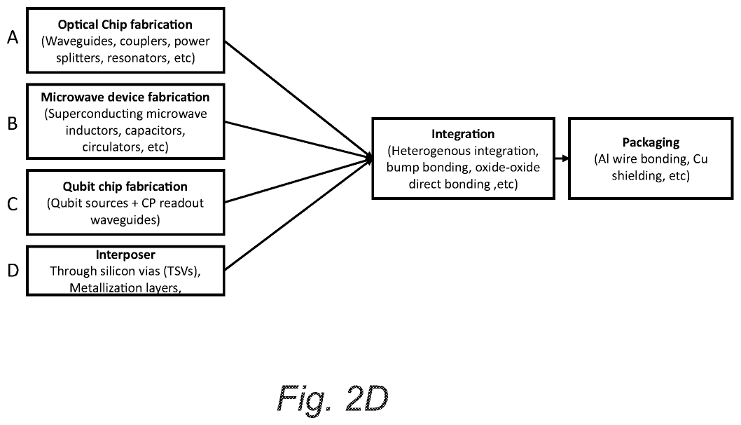

Referring to FIGS. 2A and 2B (E1), schematics of a heterogeneous quantum device are provided. FIG. 2A provides a 3D schematic of a QuIP for superconducting qubits with electrical and optical controls. In its simplest form, we have shown only the heterogeneously integrated qubit chip, microwave-to-optical (MO) transducer chip, and on-chip microwave circulators along with electrical, electromagnetic, and optical interconnects on a silicon interposer. The top and bottom side of the interposer is patterned with superconducting micro-strip co-planar waveguides for electrical signal routing, which are interconnected via through-silicon-vias (TSVs) [14]. Though silicon is the most compatible platform for qubit integration, microwave electronics, and photonics, integrating qubits on the interposer itself causes electromagnetic interference due to leaky dielectric cladding of the optical waveguides. Moreover, planar integration of the SC qubits on the interposer reduces the scalability. On the other hand, the performance of flip chip bonded qubits has been reported recently in [15], [16] on a silicon platform. We use a similar concept where the qubit chip is flip-chip bonded to the interposer using niobium (Nb) or indium (In) bonds and electrically connected to the bottom superconducting redistribution layer via TSVs. In the described QuIP scheme, the qubit chip shares microwave signals directly with the heterogeneously integrated MO transducer via inductive or capacitive coupling, as shown in the cross-section in FIGS. 2(B) and 2(C). We found that the inductive coupling exhibits greater alignment tolerances in the range of 5-10 μm for >90% coupling.

A bidirectional transducer converts quantum microwave photons to the optical domain and vice versa [18], [19]. This allows optical quantum communication between different nodes in a quantum network (cryogenic or non-cryogenic). For compact and scalable integration, electro-optic (EO) transducers are widely preferred over other types of MO transducer such as optomechanic, piezo-opto-mechanic, magnonic, etc. In this variation, an EO quantum transducer in the AlN-on-Sapphire platform, which can be heterogeneously integrated on the interposer chip is provided. LiNbO3-on-insulator (LNOI) is an alternative platform for EO transducer with a large EO coefficient; however, integration of lithium niobate (LN) is relatively complex compared to AlN-on-Sapphire.

Referring to FIGS. 2A and 2B, heterogeneous quantum device 20 includes interposer 22 over which patterned top metal layer 24 is disposed. Top metal layer 24 can function as a ground. Qubit circulator 24 a transducer chip 26 are also disposed over interposer 22. Transducer chip 26 includes microwave resonator 28 and optical microdisk resonator cavity 30 which are in optical communication with optical waveguides 32 via edge coupler 34. V-grooves 36 hold Input/output fiber 38 in place relative to edge coupler 34. SC qubit chip (flip chip bonded) 40 is flip bonded to TSVs 42. SC qubit chip (flip chip bonded) 40 includes qubit sources (on qubit chip) 48. Interposer 22 is disposed over SC RDL 44 on a packaging layer. Microwave circuits are disposed on interposer 46. Also depicted in FIG. 2A are bumps and bonding pads 50 and wire bonding pads 52. The variation depicted in FIGS. 2A and 2B includes silicon interposer recess 54 for optical chip integration.

FIG. 2D depicts a method for forming the optical chip optical interposer of FIGS. 2A and 2B. In step A), an optical chip is fabricated. In step B), a microwave device is fabricated. In step C), a qubit chip is fabricated. The components are integrated and then packaged. The combination of the optical chip and the microwave device provide a superconducting qubit to optical photon transducer (Optomechanical, Electro-optic, Electro-opto-mechanic, Opto-magnonics, etc.). In a variation, the optical chip and the microwave device can be fabricated on the same chip [20]. In another variation, the optical chip, the microwave device, and the qubit chip can be fabricated on the same chip [21]. In a refinement, the interposer can be fabricated on separate chip [22,23].

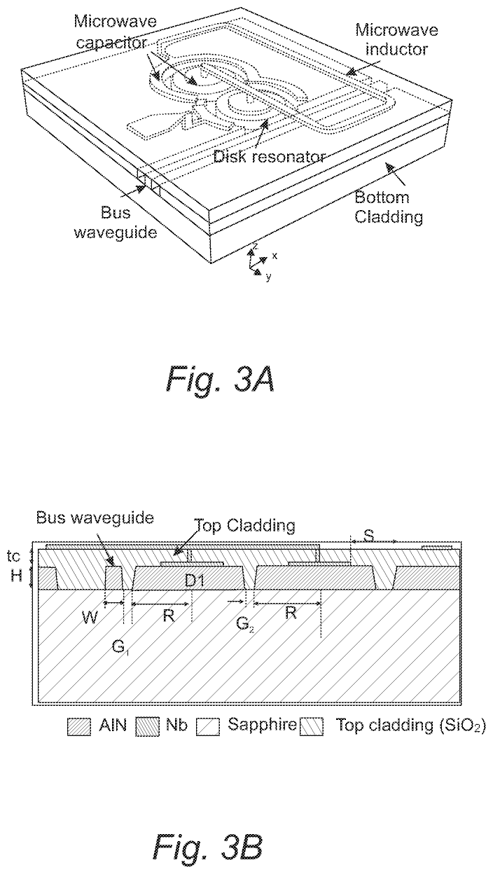

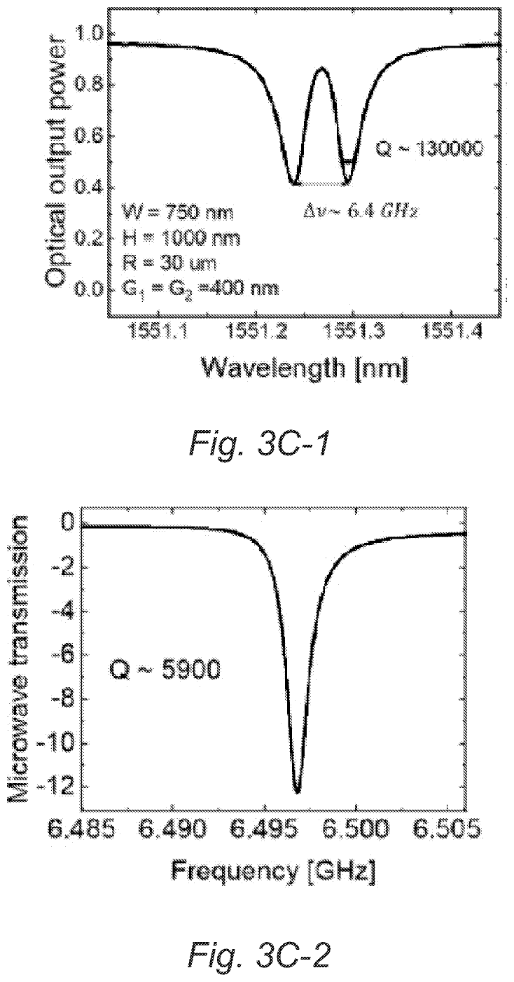

Referring to FIGS. 3A, 3B, and 3C, an EO transducer (FIG. 3(A)) that is based on two coupled WGM disk resonators (D1 and D2), where one of the disks (D1) is coupled to an input/output bus waveguide is provided. When both the disk resonators have identical intrinsic resonance condition (resonant frequency, ω₁=ω₂=ω₀ and quality factor, Q₁=Q₂=Q₀) and strongly coupled, (extrinsic Q factor Q_{c}<<Q₀), the optical transmission characteristics shows two identical split resonances (Autler-Townes resonance splitting [24]) at ωₗ and ωᵤ, centered at ω₀. We make use of these split resonance characteristics to design an EO microwave-to-optical frequency converter through non-linear sum frequency generation process as ωᵤ=ωₗ+Ω_{M}, where the optical free spectral range (FSR=ωᵤ−ωₗ) is detuned to the input microwave frequency Ω_{M}. FIG. 3(C) (left) shows the optical transmission characteristics of the coupled disk resonator (radius, R=30 μm) designed on a 750 nm thick AlN (EO coefficient ˜1 μm/V) on sapphire substrate and 400 nm SiO₂ top cladding. A superconducting (typically Nb or NbN) microwave LC resonator is integrated above the disk resonators where the capacitor electrodes are placed directly on top of the AlN layer (in the slab region as shown in FIG. 3(B)), and the lumped inductor is placed above the SiO₂ cladding connected through vias. The minimum separation between the capacitor electrodes is estimated to be s=2.5 μm, for minimum insertion loss due to mode overlap with the metal and maximum coupling between optical and microwave modes. As mentioned earlier, the microwave resonators are physically isolated and inductively coupled to the qubit chip (see FIG. 2(C)). FIG. 3(C)(right) shows the microwave resonator characteristics near resonance frequency Ω_{M}˜6.5 GHZ, which is nearly equal to the FSR of the optical spectrum. Additional bias capacitor is also provided to detune the optical characteristics electrically. The loaded optical and microwave Q-factors are calculated to be Qₒₚₜ=1.1×10⁵ and Q_{M}=5900, respectively. The EO coupling rate g-factor [25] of our device is calculated to be 7.35 kHz (g/2π=1.17 kHz), assuming the microwave capacitor covers half of the total perimeter of the device. The coupling rate can be further improved by changing the location and geometry of the microwave capacitor electrodes for maximum optical and microwave mode overlap. More details of this device can be seen elsewhere.

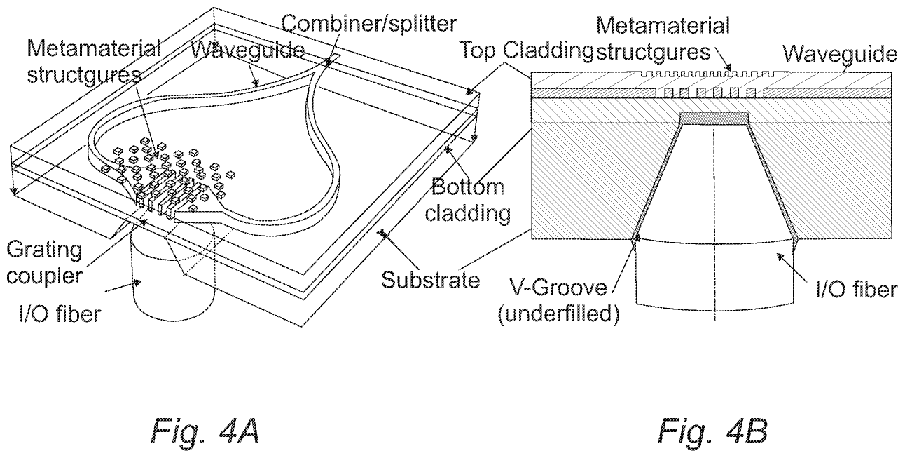

Input/output fiber interfacing is another important consideration when operating in cryogenic temperatures. The converted quantum information in the optical domain is coupled to input/output optical fibers and then transported to a cryogenic/non-cryogenic environment for processing. Unlike coupling at room temperature [26], fiber-to-chip coupling in the cryogenic temperature is expected to have very high mechanical and thermal stability. The temperature-dependent expansion or contraction of the adhesive materials might lead to coupling induced loss. In the QUIP scheme we have shown the edge coupler where fiber is mounted in the V-grooves of the Si interposer and aligned with the waveguides in the AlN-on-Sapphire transducer chip. One can also use phase-matched couplers [27] to couple fibers directly to the Si waveguides (on the interposer) which then evanescently couple to the top transducer waveguides. Due to high wavelength dependency, possible scattering loss, and mechanical instability, grating couplers (coupling from the top of the chip) are expected not a viable solution. Plug-and-play fiber to waveguide coupling using 3D funnel structures [28] and fiber-to-chip directional coupling using tapered fibers [29][30][31]-[32] are other techniques preferred over conventional edge couplers [33]. FIG. 4 shows a backside optical coupling (BOC) compatible for cryogenic packaging. The BOC technique comprises vertically mounted fiber from the backside of the chip and coupled to the grating couplers (GC) in the device layer with metamaterial structures integrated to eliminate back reflections/substrate-leakage. As a result, the BOC provides better single-photon qubit optical coupling (<1 dB loss), negligible back reflection, and higher mechanical stability for cryogenic quantum chip applications. More details on this work will be available elsewhere.

The interposer chip is also compatible for integrating on-chip microwave quantum Hall circulators which are 1000 times smaller than conventional nonreciprocal 3D cavity circulators based on ferrite devices [34], [35]. Recently, Martinez et al. reported a micron-sized cryogenic nonreciprocal circulator based on topological materials that exhibits more than 20 dB isolation at the fundamental plasmon frequency f=0.65 GHZ and over a bandwidth of ˜160 MHz. Such directional interconnects are highly demanded for a fault tolerant machine to increase the coherence time and reduce the error rate below the threshold value for quantum error correction. Inserting magnetic material into photonic crystals breaks the time reversal symmetry and induce chiral edge modes for optical photons. Such chiral optical interconnects will be beneficial for photonic and cold-atom quantum systems, as well as long-haul quantum networks exploiting telecom bandwidth.

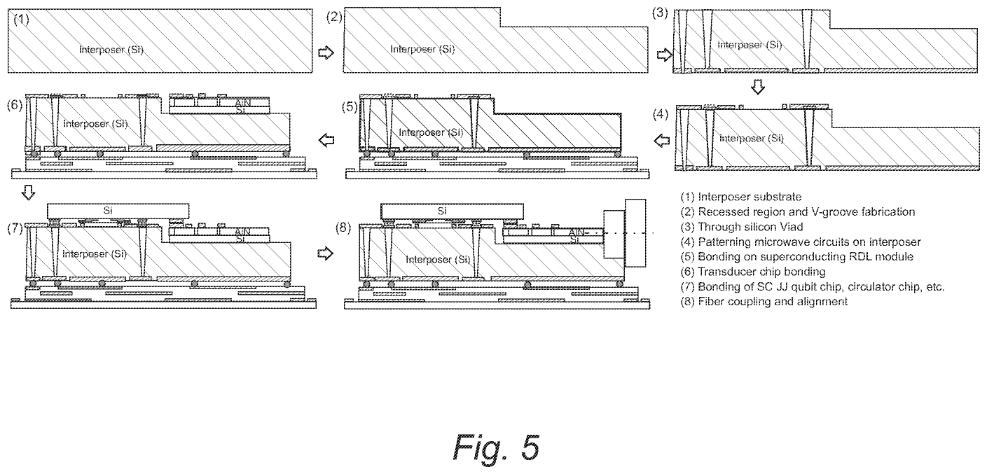

FIG. 5 shows a typical QuIP integration flow, and in particular, a schematic flowchart showing the fabrication of the optical chip optical interposer of FIGS. 2A and 2B. Again, the assumption is that the functional chips are already fabricated and brought together for integrating on the interposer. However, there are patterning and integration challenges that must be addressed to envisage a functional interposer circuit to interconnect these chips. Besides, the assembly, test, fiber, laser connections, electrical inputs shall add to the complexity of deployment of the interposer. These challenges will become increasingly significant as more qubits and functionally diverse elements are integrated on the interposer. Some apparent challenges include solutions to address thermal and electromagnetic isolations when various functional devices are integrated together.

Still referring to FIG. 5, an interposer substrate is provided in step 1). In step 2), a recessed region and V-groove are fabricated. In step 3), “Through silicon Vias” are fabricated. In step 4), microwave circuits are patterned on the interposer. In step 5), a superconducting RDL module In step 6, a transducer chip is bonded on the interposer on a bottom face. In step 7), a JJ qubit chip, circulator chip, etc. is bonded to the assembly. In step 8, an optical fiber is coupled and aligned to the assembly.

In addition, clever and disruptive packaging approaches that address the design-for-manufacturing cost targets require to be implemented to address not just the integration scheme but also the optical (fiber to laser and laser to die) and electrical I/O.

The starting material for the interposer flow is silicon. The reason for using silicon is its cryogenic characteristics, case of designing an I/O scheme and negligible microwave dielectric loss as compared to other substrates like sapphire and silicon dioxide. Moreover, thick silicon interposer region isolates the qubits from electromagnetic interference from the bottom circuits. The silicon substrate is now prepared through patterning to integrate various functional devices, including superconducting junction, transducer elements, and photonics waveguides. The silicon substrate is then thinned and polished to fabricate TSVs, a standard process. The TSV process can also be a last step in the interposer flow. Based on the optical I/O integration schemes, either a backside V-groove coupler or an adiabatic coupler will be designed on the interposer. Following the patterning of functional regions, each of these functional chips is separately integrated onto the substrate either using electrostatic bonding or metal to metal fusion bonding process schemes. For example, as shown in FIG. 5, the transducer chip is first bonded to the interposer and then the qubit chip is flip chip bonded while aligning the feed-lines to the transducer chip (see FIG. 2). In the final stage the chip is wire bonded and input/output fibers are connected. The chip is then packaged in a cryogenic housing with proper thermalization and electromagnetic shielding [36], [37], [38].

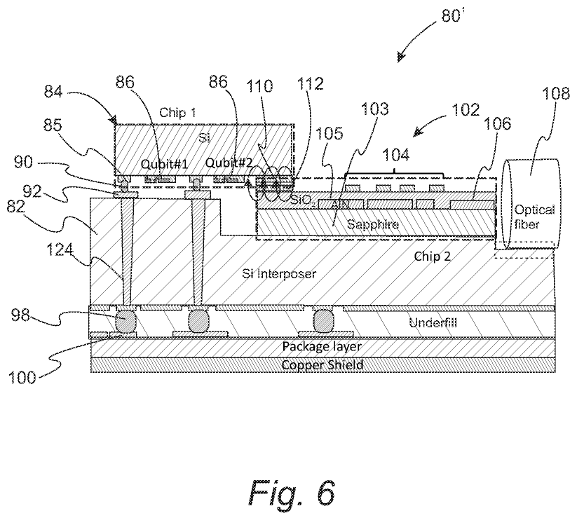

FIG. 6 depicts a variation of a heterogeneous quantum device having a 3D integrated quantum chip optical interposer chip on Si, vertical inter-chip inductive coupling of microwave field between qubit chip and frequency converter, and heterogeneous thin film bonding of optical chip with superconducting resonators (chip 2) on the interposer. Heterogeneous quantum device 80¹ includes interposer 82. Qubit chip 84 (chip 1) is disposed over interposer 82 and can be fabricated on a Si substrate. Qubit chip (chip 1) 84 includes qubit sources 86 that can be Al/AlOₓ/Al or NbN/AlN/NbN Josephson Junctions (JJs). Qubit chip 84 (chip 1) also includes coplanar waveguides (CPW) 85 [22,36] for qubit bias and readout [22,23]. The CPW 85 can be made of Al or Nb or NbTiN. In a refinement Qubit chip 84 (chip 1) is flip chip bonded to interposer 82 and biased using In or Nb bump bonds 90 through the TSVs (TiN or NbN) and metallization layer 92 [16]. Bump bonds 98 and bonding pads 100 ‘are given at the bottom of the interposer for external electrical connection [16, 36]. Electro-optic quantum transducer 102 (chip 2) converts microwave frequency to optical frequency. Typically, waveguides 105 are composed of high electro-optic coefficient materials. In a refinement, AlN or LiNbO₃ is used as the waveguide core and SiO₂ or Al₂O₃ (Sapphire) is used as the cladding/substrate. Electro-optic quantum transducer 102 (chip 2) also includes microwave resonators 104 of Al or Nb or NbTiN [39]. Edge couplers 106 are integrated on the AlN optical layer and aligned with the optical fiber 108 which is mounted in the V-groove of the interposer. In a refinement, electro-optic quantum transducer 102 (chip 2) is pre-fabricated and heterogeneously bonded to the interposer using thin film bonding. In another refinement, electro-optic quantum transducer 102 (chip 2) is formed from a sapphire substrate 103 that is heterogeneously bonded first and AlN layer is grown using a templated growth process. As depicted in FIG. 6, microwave inductive feedlines 110 qubit chip 84 (chip 1) and microwave inductive feedlines 112 on electro-optic quantum transducer 102 (chip 2) provide vertical inter-chip inductive coupling of a microwave field between qubit chip 84 (chip 1) and electro-optic quantum transducer 102 (chip 2) (a frequency converter).

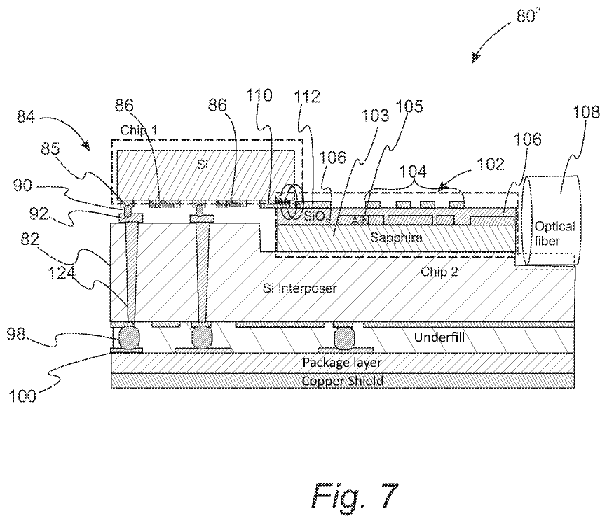

FIG. 7 depicts a variation of a heterogeneous quantum device having a 3D integrated quantum chip optical interposer chip on Si, In-plane inter-chip inductive coupling of microwave field between flip-chip bonded qubit chip and frequency converter, and heterogeneous thin film bonding of optical chip with superconducting resonators (chip 2) on the interposer. Heterogeneous quantum device 802 includes interposer 82. Qubit chip 84 (chip 1) is disposed over interposer 82 and can be fabricated on a Si substrate. Qubit chip (chip 1) 84 includes qubit sources 86 that can be Al/AlOₓ/Al or NbN/AlN/NbN Josephson Junctions (JJs). Qubit chip 84 (chip 1) also includes coplanar waveguides (CPW) 85 [22,36] for qubit bias and readout [22,33]. CPW 85 can be made of Al or Nb or NbTiN. In a refinement Qubit chip 84 (chip 1) is flip chip bonded to interposer 82 and biased using In or Nb bump bonds 90 through the TSVs (TiN or NbN) and metallization layer 92. [40,36] bump bonds 98 and bonding pads 100 ‘are given at the bottom of the interposer for external electrical connection [16,36]. Electro-optic quantum transducer 102 (chip 2) converts microwave frequency to optical frequency. Typically, waveguides 105 are composed of high electro-optic coefficient materials. In a refinement, AlN or LiNbO₃ is used as the waveguide core and SiO₂ or Al₂O₃ (Sapphire) is used as the cladding/substrate. Electro-optic quantum transducer 102 (chip 2) also includes microwave resonators 104 of Al or Nb or NbTiN Edge couplers 106 are integrated on the AlN optical layer and aligned with the optical fiber 108 which is mounted in the V-groove of the interposer. In a refinement, electro-optic quantum transducer 102 (chip 2) is pre-fabricated and heterogeneously bonded to the interposer using thin film bonding. In another refinement, electro-optic quantum transducer 102 (chip 2) is formed from a sapphire substrate 103 that is heterogeneously bonded first and AlN layer is grown using a templated growth process. As depicted in FIG. 7, microwave inductive feedlines 110 on qubit chip 84 (chip 1) and microwave inductive feedlines 112 on electro-optic quantum transducer 102 (chip 2) provide in-plane inter-chip inductive coupling of a microwave field between qubit chip 84 (chip 1) and electro-optic quantum transducer 102 (chip 2) (a frequency converter).

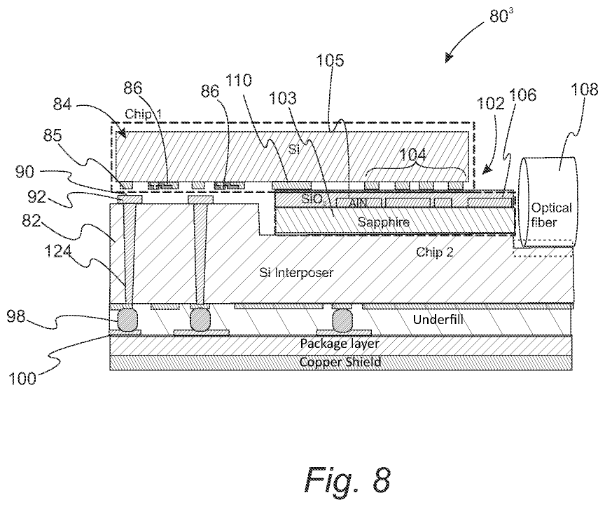

FIG. 8 depicts a variation of a heterogeneous quantum device having a 3D integrated quantum chip optical interposer chip on Si and heterogeneous thin film bonding of optical chip (chip 2) on the interposer. Heterogeneous quantum device 80³ includes interposer 82. Qubit chip 84 (chip 1) is disposed over interposer 82 and can be fabricated on a Si substrate. Qubit chip (chip 1) 84 includes qubit sources 86 that can be Al/AlOₓ/Al or NbN/AlN/NbN Josephson Junctions (JJs). Qubit chip 84 (chip 1) also includes coplanar waveguides (CPW) 85 [22,36] for qubit bias and readout and microwave resonators [22,40]. CPW 85 can be made of Al or Nb or NbTiN. In a refinement qubit chip 84 (chip 1) is flip chip bonded to interposer 82 and biased using In or Nb bump bonds 90 through the TSVs (TiN or NbN) and metallization layer 92. [40,36] bump bonds 98 and bonding pads 100 ‘are given at the bottom of the interposer for external electrical connection [16, 36]. Electro-optic quantum transducer 102 (chip 2) converts microwave frequency to optical frequency. Typically, waveguides 105 are composed of high electro-optic coefficient materials. In a refinement, AlN or LiNbO₃ is used as the waveguide core and SiO₂ or Al₂O₃ (Sapphire) is used as the cladding/substrate. Optical chip 102 (chip 2) includes waveguides 105 and optical cavities of high electro-optic coefficient material (such as AlN or LiNbO₃ for a waveguide core and SiO₂ or Al₂O₃ (sapphire for a cladding/substrate). [39] The capacitors of the microwave resonator 104 in Qubit chip 84 (chip 1) is aligned on top of the optical resonator cavity forming an electro-optic frequency converter. Edge couplers 106 are integrated on the AlN optical layer and aligned with the optical fiber 108 which is mounted in the V-groove of the interposer. In a refinement, electro-optic quantum transducer 102 (chip 2) is pre-fabricated and heterogeneously bonded to the interposer using thin film bonding. In another refinement, electro-optic quantum transducer 102 (chip 2) is formed from a sapphire substrate 103 that is heterogeneously bonded first and AlN layer is grown using a templated growth process. As depicted in FIG. 8, microwave inductive feedlines 110 on qubit chip 84 (chip 1) are also depicted.

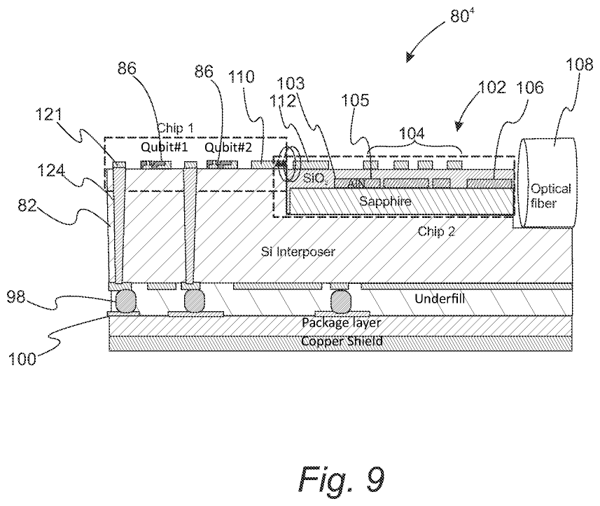

FIG. 9 depicts a variation of a heterogeneous quantum device having a 3D integrated quantum chip optical interposer chip on Si, in-plane inter-chip inductive coupling of microwave field between qubit chip on the interposer and the frequency converter (Josephson Junction is monolithically integrated on the interposer), and heterogeneous thin film bonding of optical chip with superconducting resonators (chip 2) on the interposer. Heterogeneous quantum device 80⁴ includes interposer 82. Qubit sources 86 and coplanar waveguides (CPW) 121 are monolithically fabricated on the interposer [22,40]. The region of the interposer including the qubit sources formally forms qubit chip 84 (chip 1). In a refinement, Al/AlOₓ/Al or NbN/AlN/NbN Josephson Junctions (JJs) are typically used as qubit sources and Al or Nb or NbTiN is used as CPW 121 for qubit bias and readout [22,33]. Qubit sources 86 are biased using In or Nb bump bonds 120 through the TSVs (TiN or NbN) and metallization layer. Bump bonds 98 and bonding pads 100 are given at the bottom of the interposer for external electrical connection [36,36]. Electro-optic quantum transducer 102 (chip 2) converts microwave frequency to optical frequency. Typically, waveguides 105 are composed of high electro-optic coefficient materials such as AlN or LiNbO₃ can be used as the waveguide core and SiO₂ or Al₂O₃ (Sapphire) can be used as the cladding/substrate. Chip 2 also consists of microwave resonators of Al or Nb er NbTiN [39]. Edge couplers 106 are integrated on the AlN optical layer and aligned with the optical fiber which is mounted in the V-groove of the interposer. In a refinement, electro-optic quantum transducer 102 (chip 2) is pre-fabricated and heterogeneously bonded to the interposer using thin film bonding. In another refinement, electro-optic quantum transducer 102 (chip 2) is formed from a sapphire substrate 103 that is heterogeneously bonded first and AlN layer is grown using a templated growth process. As depicted in FIG. 9, microwave inductive feedlines 110 on qubit chip 84 (chip 1) and microwave inductive feedlines 112 on electro-optic quantum transducer 102 (chip 2) provide in-plane inter-chip inductive coupling of a microwave field between qubit chip 84 (chip 1) and electro-optic quantum transducer 102 (chip 2) (a frequency converter).

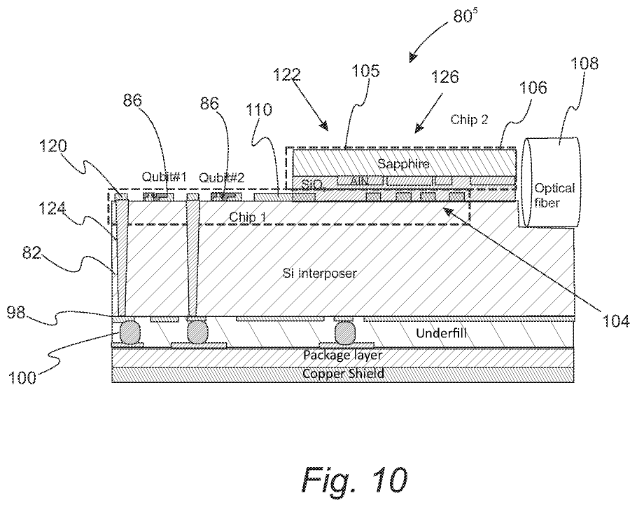

FIG. 10 depicts a variation of a heterogeneous quantum device having a 3D integrated quantum chip optical interposer chip on Si, flip-chip bonding optical resonator chip over the microwave resonators (all microwave circuits are monolithically integrated on to the interposer and optical chip is separately bonded and integrated), and thin film flip chip bonding of optical chip (chip 2) with the interposer. Heterogeneous quantum device 805 includes interposer 82. Qubit sources 86, coplanar waveguides (CPW) and microwave resonators are monolithically fabricated on the interposer 82 [22, 40]. The region of the interposer including the qubit sources formally forms qubit chip 84 (chip 1). As set forth above, Al/AlOₓ/Al or NbN/AlN/NbN Josephson Junctions (JJs) can be used as qubit sources and Al or Nb or NbTiN can be used as CPW for qubit bias and readout [22,33]. Qubit sources 86 are biased using In or Nb bump bonds 120 through the TSVs 124 (TiN or NbN) and metallization layer. [16]. Bump bonds 98 and bonding pads 100 are given at the bottom of the interposer for external electrical connection. [16, 36]. Optical chip 122 (chip 2) includes waveguides and optical cavities of high electro-optic coefficient material (such as AlN or LiNbO₃ for the waveguide core and SiO₂ or Al₂O₃ (Sapphire) for the cladding/substrate. [39]. The capacitors of the microwave resonator 104 in interposer 82 (i.e., chip 1) is aligned on top of the optical resonator cavity forming an electro-optic frequency converter 126. Edge couplers 106 are integrated on the AlN optical layer and aligned with the optical fiber 108 which is mounted in the V-groove of the interposer. Optical chip 122 (chip 2) is flip-chip bonded to the interposer. In a refinement, optical chip 122 (chip 2) is flip-chip bonded to the interposer by thin film oxide-oxide bonding. As depicted in FIG. 10, microwave inductive feedlines 110 on qubit chip 84 (chip 1) are also depicted.

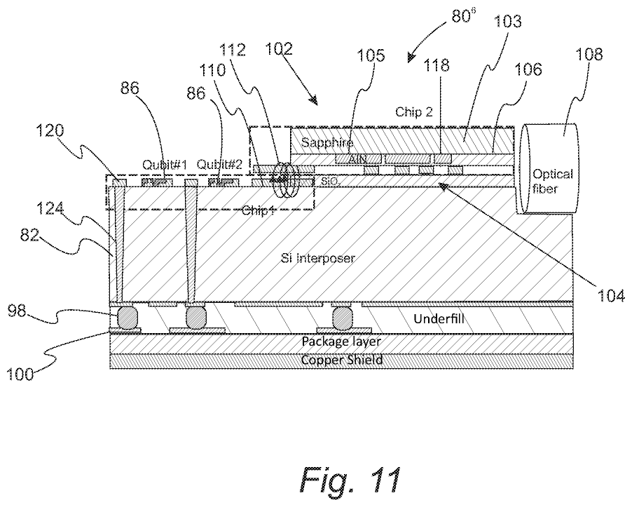

FIG. 11 depicts a variation of a heterogeneous quantum device having 3D integrated quantum chip optical interposer chip on Si, vertical inter-chip inductive coupling of microwave field between qubit chip (monolithically integrated on to the interposer) and frequency converter, and fiber coupling is to the optical chip that is bonded on the interposer. Heterogeneous quantum device 806 includes interposer 82. Qubit sources 86 and coplanar waveguides (CPW) of chip 1 are monolithically fabricated on the interposer 82. [22.40]. The region of the interposer including the qubit sources formally forms qubit chip 84 (chip 1). As set forth above, Al/AlOₓ/Al or NbN/AlN/NbN Josephson Junctions (JJs) are typically used as qubit sources. [33]. In a refinement, Al or Nb or NbTiN can be used as CPW for qubit bias and readout [22,33]. Qubits are biased using In or Nb bump bonds 120 through the TSVs (TiN or NbN) and metallization layer. [16, 36]. Bump bonds 98 and bonding pads 100 are given at the bottom of the interposer for external electrical connection [39]. Electro-optic quantum transducer 102 (chip 2) converts microwave frequency to optical frequency. Typically, waveguides 105 are composed of high electro-optic coefficient materials such as AlN or LiNbO₃ is used as the waveguide core and SiO₂ or Al₂O₃ (Sapphire) is used as the cladding/substrate [39]. Electro-optic quantum transducer 102 (chip 2) also consists of microwave resonators of Al or Nb or NbTiN [39]. Edge couplers 106 are integrated on the AlN optical layer and aligned with the optical fiber which is mounted in the V-groove of the interposer 82. Electro-optic quantum transducer 102 (chip 2) is flip-chip bonded to the interposer. In a refinement, Electro-optic quantum transducer 102 (chip 2) is flip-chip bonded to the interposer 82 by thin film oxide-oxide bonding. As depicted in FIG. 11, microwave inductive feedlines 110 on qubit chip 84 (chip 1) and microwave inductive feedlines 112 on electro-optic quantum transducer 102 (chip 2) provide in-plane inter-chip inductive coupling of a microwave field between qubit chip 84 (chip 1) and electro-optic quantum transducer 102 (chip 2) (a frequency converter). As depicted in FIG. 11, microwave inductive feedlines 110 on qubit chip 84 (chip 1) and microwave inductive feedlines 112 on electro-optic quantum transducer 102 (chip 2) provide vertical inter-chip inductive coupling of a microwave field between qubit chip 84 (chip 1) and electro-optic quantum transducer 102 (chip 2) (a frequency converter). Optical waveguides and resonator cavity 118 is also depicted.

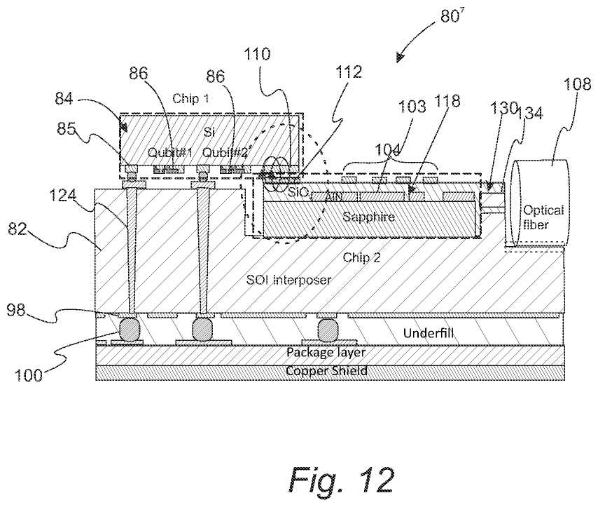

FIG. 12 depicts a variation of a heterogeneous quantum device having a 3D integrated quantum chip optical interposer chip on Si, vertical inter-chip inductive coupling of microwave field between qubit chip and frequency converter, and butt coupling/evanescent field coupling between interposer waveguide and chip2 waveguides (Fiber coupling is to the interposer waveguide). Heterogeneous quantum device 807 includes interposer 82. Qubit chip 84 (chip 1) can be fabricated on a Si substrate and it consists of qubit sources and coplanar waveguides (CPW) [22,40]. As set forth above, Al/AlOₓ/Al or NbN/AlN/NbN Josephson Junctions (JJs) can be used as qubit sources and Al or Nb or NbTiN can be used as CPW for qubit bias and readout [22,33]. Qubit chip 84 (chip 1) is flip chip bonded to interposer and biased using In or Nb bump bonds through the TSVs (TiN or NbN) and metallization layer [16]. Bump bonds 98 and bonding pads 100 are given at the bottom of the interposer for external electrical connection [16, 36]. Electro-optic quantum transducer 102 (chip 2) converts microwave frequency to optical frequency. Typically, high electro-optic coefficient materials such as AlN or LiNbO₃ is used as the waveguide core and SiO₂ or Al₂O₃ (sapphire) is used as the cladding/substrate. Electro-optic quantum transducer 102 (chip 2) also consists of microwave resonators of Al or Nb or NbTIN [39]. Edge couplers 106 are integrated on the interposer and aligned with the optical fiber 108 which is mounted in the V-groove of the interposer 82. Butt coupling or evanescent field coupling 130 can be used to couple light between the interposer 82 and frequency converter chip (i.e., electro-optic quantum transducer) through Si waveguide 134. Electro-optic quantum transducer 102 (chip 2) can be pre-fabricated and heterogeneously bonded to the interposer 82 using thin film bonding. In a refinement, Electro-optic quantum transducer 102 (chip 2) includes sapphire substrate 103 is heterogeneously bonded first and AlN layer is grown using templated growth process. As depicted in FIG. 12, microwave inductive feedlines 110 on qubit chip 84 (chip 1) and microwave inductive feedlines 112 on electro-optic quantum transducer 102 (chip 2) provide vertical inter-chip inductive coupling of a microwave field between qubit chip 84 (chip 1) and electro-optic quantum transducer 102 (chip 2) (a frequency converter). Optical waveguides and resonator cavity 118 is also depicted. As depicted in FIG. 12, microwave inductive feedlines 110 on qubit chip 84 (chip 1) and microwave inductive feedlines 112 on electro-optic quantum transducer 102 (chip 2) provide vertical inter-chip inductive coupling of a microwave field between qubit chip 84 (chip 1) and electro-optic quantum transducer 102 (chip 2) (a frequency converter). Optical waveguides and resonator cavity 118 is also depicted.

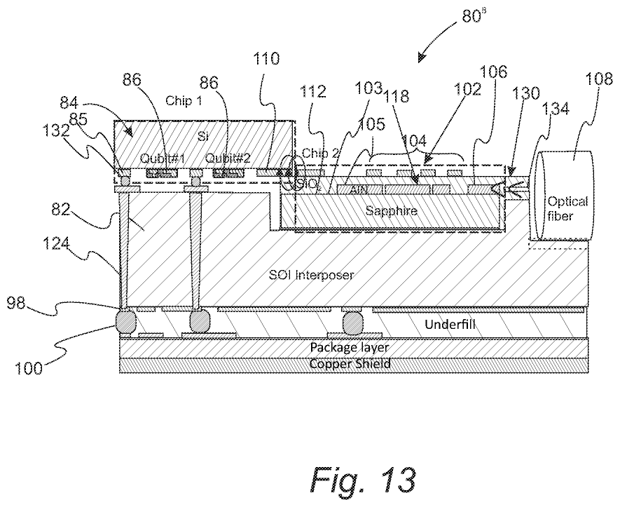

FIG. 13 depicts a variation of a heterogeneous quantum device having a 3D integrated quantum chip optical interposer chip on Si, in-plane inter-chip inductive coupling of microwave field between qubit chip and frequency converter, and butt coupling/evanescent field coupling between interposer waveguide and chip2 waveguides. This variation is a combination of the heterogenous quantum device of FIGS. 7 and 12. Heterogeneous quantum device 808 includes interposer 82. Qubit chip 84 (chip 1) can be fabricated on a Si substrate and it consists of qubit sources and coplanar waveguides (CPW) [22,40]. As set forth above, Al/AlOₓ/Al or NbN/AlN/NbN Josephson Junctions (JJs) are typically used as qubit sources [23]. In a refinement, Al or Nb or NbTiN is used as CPW for qubit bias and readout [22,23]. Qubit chip 84 (chip 1) is flip chip bonded to interposer 82 and biased using In or Nb bump bonds 132 through the TSVs 124 (TiN or NbN) and metallization layer. [16]. Bump bonds 98 and bonding pads 100 are given at the bottom of the interposer for external electrical connection [16, 36] Electro-optic quantum transducer 102 (chip 2) converts microwave frequency to optical frequency. Typically, high electro-optic coefficient materials such as AlN or LiNbO₃ is used as the waveguide core and SiO₂ or Al₂O₃ (Sapphire) is used as the cladding/substrate. [39] Electro-optic quantum transducer 102 (chip 2) also includes microwave resonators of Al or Nb or NbTiN [39]. Edge couplers 106 are integrated on the interposer and aligned with the optical fiber 108 which is mounted in the V-groove of the interposer. Butt coupling or evanescent field coupling 130 can be used to couple light between the interposer 82 and frequency converter chip (Electro-optic quantum transducer 102) through Si waveguide 134. Electro-optic quantum transducer 102 (chip 2) can be pre-fabricated and heterogeneously bonded to the interposer 82 using thin film bonding. In a refinement, electro-optic quantum transducer 102 (chip 2) includes sapphire substrate 103 is heterogeneously bonded first and AlN layer is grown using templated growth process. As depicted in FIG. 13, microwave inductive feedlines 110 on qubit chip 84 (chip 1) and microwave inductive feedlines 112 on electro-optic quantum transducer 102 (chip 2) provide in-plane inter-chip inductive coupling of a microwave field between qubit chip 84 (chip 1) and electro-optic quantum transducer 102 (chip 2) (a frequency converter). Optical waveguides and resonator cavity 118 is also depicted. Optical waveguides and resonator cavity 118 is also depicted.

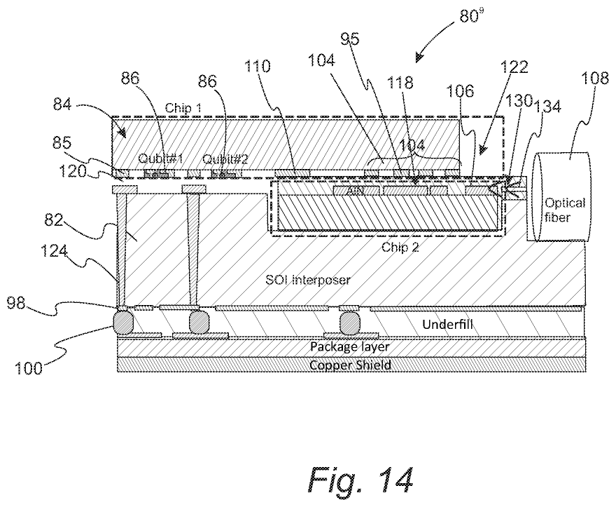

FIG. 14 depicts a variation of a heterogeneous quantum device having a 3D integrated quantum chip optical interposer chip on Si, heterogeneous thin film bonding of optical chip (chip 2) on the interposer and butt coupling/evanescent field coupling between interposer waveguide and chip2 waveguides. This variation is a combination of the heterogenous quantum device of FIGS. 8 and 12. Qubit chip 84 (chip 1) can be fabricated on a Si substrate and it consists of qubit sources, coplanar waveguides (CPW) and microwave resonators [22,40]. As set forth above, Al/AlOₓ/Al or NbN/AlN/NbN Josephson Junctions (JJs) are typically used as qubit sources [23]. In a refinement, Al or Nb or NbTiN is used as CPW 85 for qubit bias and readout [22,23]. Qubit chip 84 (chip 1) is flip chip bonded to interposer 80⁸ and biased using In or Nb bump bonds 120 through the TSVs 124 (TiN or NbN) and metallization layer. [16]. Bump bonds 98 and bonding pads 100 are given at the bottom of the interposer for external electrical connection [16, 36]. Optical chip 122 (chip 2) consists of waveguides 95 and optical cavities 118 of high electro-optic coefficient material (such as AlN or LiNbO₃ for the waveguide core and SiO₂ or Al₂O₃ (Sapphire) for the cladding/substrate. [39]. The capacitors of the microwave resonator 104 in qubit chip 84 (chip 1) is aligned on top of the optical resonator cavity 118 forming an electro-optic frequency converter. Edge couplers 106 are integrated on the interposer and aligned with the optical fiber 108 which is mounted in the V-groove of the interposer. Butt coupling or evanescent field coupling 130 can be used to couple light between the interposer and frequency converter chip through Si waveguide 134. Optical chip 122 (chip 2) can be pre-fabricated and heterogeneously bonded to the interposer using thin film bonding. In a refinement, optical chip 122 (chip 2) includes sapphire substrate 103 is heterogeneously bonded first and AlN layer is grown using templated growth process. As depicted in FIG. 14, microwave inductive feedlines 110 on qubit chip 84 (chip 1) and microwave inductive feedlines 112 on electro-optic quantum transducer 102 (chip 2) provide in-plane inter-chip inductive coupling of a microwave field between qubit chip 84 (chip 1) and electro-optic quantum transducer 102 (chip 2) (a frequency converter). FIG. 14 also depicts microwave feed lines 110 disposed over qubit chip 84.

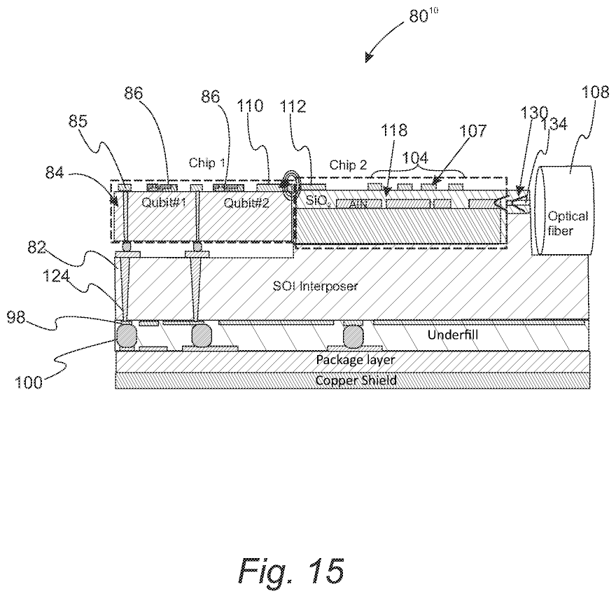

FIG. 15 depicts a variation of a heterogeneous quantum device having a 3D integrated quantum chip optical interposer chip on Si, in-plane inter-chip inductive coupling of microwave field between qubit chip and frequency converter, heterogeneous thin film bonding of optical chip (chip 2) on the interposer, and butt coupling/evanescent field coupling between interposer waveguide and chip2 waveguides. This variation is a combination of the heterogenous quantum devices of FIGS. 9 and 12. Heterogeneous quantum device 80¹⁰ includes interposer 82. Qubit chip (chip 1) 84 can be fabricated on a Si substrate and includes qubit sources 86, coplanar waveguides 85 (CPW) and microwave resonators [22,40]. As set forth above, Al/AlOₓ/Al or NbN/AlN/NbN Josephson Junctions (JJs) are typically used as qubit sources [23]. In a refinement, Al or Nb or NbTiN is used as CPW 85 for qubit bias and readout [22,23]. Qubit chip 84 (chip 1) has TSVs and metallization layers and is bonded to the interposer using In or Nb bump bonds. The interposer 82 has TSVs 124 (TiN or NbN) and metallization layer. [16]. Bump bonds 98 and bonding pads 100 are given at the bottom of the interposer for external electrical connection [16, 36]. Optical chip 122 (chip 2) consists of waveguides 105 and optical cavities 118 of high electro-optic coefficient material (such as AlN or LiNbO₃ for the waveguide core and SiO₂ or Al₂O₃ (Sapphire) for the cladding/substrate. [39]. The capacitors 107 of optical chip 122 (chip 2) are aligned on top of the optical resonator cavity 118 forming an electro-optic frequency converter. Edge couplers 106 are integrated on the interposer 82 and aligned with the optical fiber 108 which is mounted in the V-groove of the interposer. Butt coupling or evanescent field coupling 130 can be used to couple light between the interposer and frequency converter chip through Si waveguide 134. Optical chip 122 (chip 2) can be pre-fabricated and heterogeneously bonded to the interposer using thin film bonding. In a refinement, optical chip 122 (chip 2) includes sapphire substrate 103 that is heterogeneously bonded first and AlN layer is grown using templated growth process. As depicted in FIG. 15, microwave inductive feedlines 110 on qubit chip 84 (chip 1) and microwave inductive feedlines 112 on electro-optic quantum transducer 102 (chip 2) provide vertical inter-chip inductive coupling of a microwave field between qubit chip 84 (chip 1) and electro-optic quantum transducer 102 (chip 2) (a frequency converter). Optical waveguides and resonator cavity 118 is also depicted.

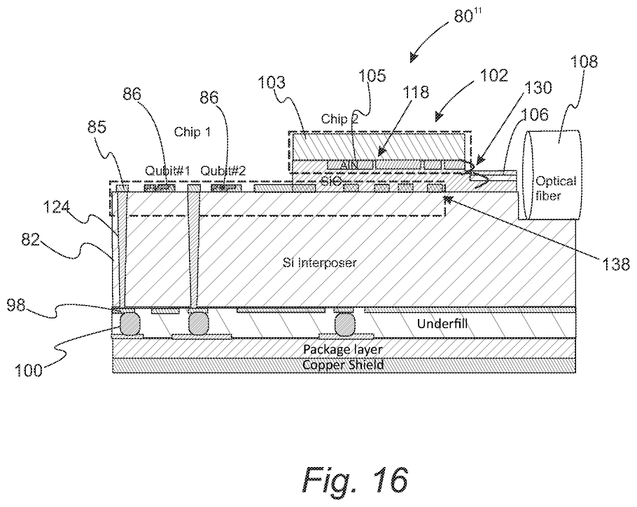

FIG. 16 depicts a variation of a heterogeneous quantum device having a 3D integrated quantum chip optical interposer chip on Si, flip-chip bonding optical resonator chip over the microwave resonators, thin film flip chip bonding of optical chip (chip 2) with the interposer, and butt coupling/evanescent field coupling between interposer waveguide and chip2 waveguides. This variation is a combination of the heterogenous quantum devices of FIGS. 10 and 12. Heterogeneous quantum device 8011 includes interposer 82. Qubit sources 86, coplanar waveguides (CPW) 85 and microwave resonators [22,40] are monolithically fabricated on the interposer 84. The region of the interposer including the qubit sources formally forms qubit chip 84 (chip 1). As set forth above, Al/AlOₓ/Al or NbN/AlN/NbN Josephson Junctions (JJs) are typically used as qubit sources [23]. In a refinement, Al or Nb or NbTiN is used as CPW 85 for qubit bias and readout [22,23]. Qubit sources are biased using In or Nb bump bonds through the TSVs (TiN or NbN) and metallization layer [16]. Bump bonds 98 and bonding pads 100 are given at the bottom of the interposer 84 for external electrical connection [16, 36]. Optical chip 122 (chip 2) includes waveguides and optical cavities of high electro-optic coefficient material (such as AlN or LiNbO₃ for the waveguide core and SiO₂ or Al₂O₃ (Sapphire) for the cladding/substrate [39]. The capacitors 138 of the microwave resonator in chip 1 (interposer) is aligned on top of the optical resonator cavity 118 forming an electro-optic frequency converter. Edge couplers are integrated on the interposer and aligned with the optical fiber which is mounted in the V-groove of the interposer. Butt coupling or evanescent field coupling 130 can be used to couple light between the interposer and frequency converter chip. In a refinement, optical chip 122 (chip 2) is Pre-fabricated and heterogeneously bonded to the interposer using thin film bonding. In a refinement, optical chip 122 (chip 2) includes a sapphire substrate 103 is heterogeneously bonded first and AlN layer is grown using templated growth process.

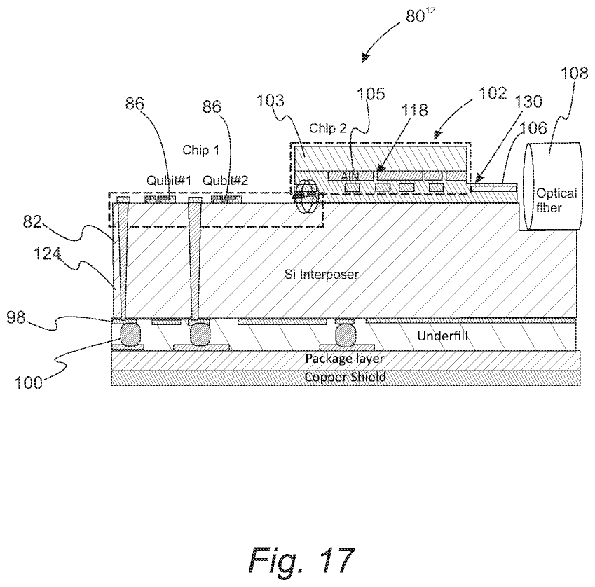

FIG. 17 depicts a variation of a heterogeneous quantum device having a 3D integrated quantum chip optical interposer chip on Si, vertical inter-chip inductive coupling of microwave field between qubit chip and frequency converter, heterogeneous thin film flip-chip bonding of optical chip with superconducting resonators (chip 2) on the interposer, and butt coupling/evanescent field coupling between interposer waveguide and chip 2 waveguides. This variation is a combination of the heterogenous quantum devices of FIGS. 11 and 12. Heterogeneous quantum device 80¹² includes interposer 82. The qubit sources and coplanar waveguides (CPW) of chip 1 are monolithically fabricated on the interposer [22,40]. As set forth above, Al/AlOₓ/Al or NbN/AlN/NbN Josephson Junctions (JJs) are typically used as qubit sources [23]. In a refinement, Al or Nb or NbTiN is used as CPW for qubit bias and readout [22,23]. Qubits are biased using In or Nb bump bonds through the TSVs (TiN or NbN) and metallization layer [16]. Bump bonds 98 and bonding pads 100 are given at the bottom of the interposer for external electrical connection [16, 36]. Electro-optic quantum transducer 102 (chip 2) converts microwave frequency to optical frequency. Typically, high electro-optic coefficient materials such as AlN or LiNbO₃ is used as the waveguide core and SiO₂ or Al₂O₃ (Sapphire) is used as the cladding/substrate. Electro-optic quantum transducer 102 (chip 2) includes microwave resonators of Al or Nb or NbTiN [39]. Edge couplers 106 are integrated on the interposer 84 and aligned with the optical fiber 108 which is mounted in the V-groove of the interposer. Butt coupling or evanescent field coupling 130 can be used to couple light between the interposer and frequency converter chip through Si waveguide 134. Electro-optic quantum transducer 102 (chip 2) can be pre-fabricated and heterogeneously bonded to the interposer using thin film bonding. In a refinement, sapphire substrate 103 is heterogeneously bonded first and AlN layer is grown using templated growth process.

Additional details of the present invention are provided in R. Kudalippalliyalil, S. Chandran, A. Jaiswal, K. L. Wang and A. P. Jacob. “Heterogeneously Integrated Quantum Chip Interposer Packaging,” 2022 IEEE 72nd Electronic Components and Technology Conference (ECTC), 2022, pp. 1869-1874, doi: 10.1109/BCTC51906.2022.00294; the entire disclosure of which is hereby incorporated by reference in its entirety.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. A. Fruchtman and I. Choi, “Technical roadmap for fault-tolerant quantum computing”, NQIT Technical Roadmap, 2016.
2. D. Awschalom, K. K. Berggren, H. Bernien, S. Bhave, L. D. Carr, P. Davids, S. E. Economou, D. Englund, A. Faraon, M. Fejer et al., “Development of quantum interconnects (quics) for next-generation information technologies”, PRX Quantum, vol. 2, no. 1, pp. 017002, 2021.
3. Q. Liu, M. Li, K. Dai, K. Zhang, G. Xue, X. Tan, et al., “Extensible 3d architecture for superconducting quantum computing”, Applied Physics Letters, vol. 110, no. 23, pp. 232602, 2017.
4. J. Béjanin, T. McConkey, J. Rinehart, C. Earnest, C. McRae, D. Shiri, J. Bateman, Y. Rohanizadegan, B. Penava, P. Breul et al., “Three-dimensional wiring for extensible quantum computing: The quantum socket”, Physical Review Applied, vol. 6, no. 4, pp. 044010, 2016.
5. S. Pauka, K. Das, R. Kalra, A. Moini, Y. Yang, M. Trainer, A. Bousquet, C. Cantaloube, N. Dick, G. Gardner et al., “A cryogenic cmos chip for generating control signals for multiple qubits”, Nature Electronics, vol. 4, no. 1, pp. 64-70, 2021.
6. J. C. Adcock, J. Bao, Y. Chi, X. Chen, D. Bacco, Q. Gong, et al., “Advances in silicon quantum photonics”, IEEE Journal of Selected Topics in Quantum Electronics, vol. 27, no. 2, pp. 1-24, 2020.
7. D.-R. W. Yost, M. E. Schwartz, J. Mallek, D. Rosenberg, C. Stull, J. L. Yoder, G. Calusine, M. Cook, R. Das, A. L. Day et al., “Solid-state qubits integrated with superconducting through-silicon vias”, npj Quantum Information, vol. 6, no. 1, pp. 1-7, 2020.
8. M. H. Devoret and R. J. Schoelkopf, “Superconducting circuits for quantum information: an outlook”, Science, vol. 339, no. 6124, pp. 1169-1174, 2013.
9. S. Krastanov, H. Raniwala, J. Holzgrafe, K. Jacobs, M. Lončar, M. J. Reagor, et al., “Optically heralded entanglement of superconducting systems in quantum networks”, Physical Review Letters, vol. 127, no. 4, pp. 040503, 2021.
10. N. Lauk, N. Sinclair, S. Barzanjeh, J. P. Covey, M. Saffman, M. Spiropulu, et al., “Perspectives on quantum transduction”, Quantum Science and Technology, vol. 5, no. 2, pp. 020501, 2020.
11. F. Lecocq, F. Quinlan, K. Cicak, J. Aumentado, S. Diddams and J. Teufel, “Control and readout of a superconducting qubit using a photonic link”, Nature, vol. 591, no. 7851, pp. 575-579, 2021.
12. B. Sirbu, Y. Eichhammer, H. Oppermann, T. Tekin, J. Kraft, V. Sidorov, et al., “3d silicon photonics interposer for tb/s optical interconnects in data centers with double-side assembled active components and integrated optical and electrical through silicon via on soi”, 2019 IEEE 69th Electronic Components and Technology Conference (ECTC), pp. 1052-1059, 2019.
13. C. Thomas, J. Charbonnier, A. Garnier, N. Bresson, F. Fournel, S. Renet, R. Franiatte, N. David, V. Thiney, M. Urdampilleta et al., “Die-to-wafer 3d interconnections operating at sub-kelvin temperatures for quantum computation”, 2020 IEEE 8th Electronics System-Integration Technology Conference (ESTC)., pp. 1-7, 2020.
14. M. Vahidpour, W. O'Brien, J. T. Whyland, J. Angeles, J. Marshall, D. Scarabelli, G. Crossman, K. Yadav, Y. Mohan, C. Bui et al., “Superconducting through-silicon vias for quantum integrated circuits”, 2017.
15. K. Satzinger, C. Conner, A. Bienfait, H.-S. Chang, M.-H. Chou, A. Cleland, É. Dumur, J. Grebel, G. Peairs, R. Povey et al., “Simple non-galvanic flip-chip integration method for hybrid quantum systems”, Applied Physics Letters, vol. 114, no. 17, pp. 173501, 2019.
16. D. Rosenberg, D. Kim, R. Das, D. Yost, S. Gustavsson, D. Hover, P. Krantz, A. Melville, L. Racz, G. Samach et al., “3d integrated superconducting qubits”, npj quantum information, vol. 3, no. 1, pp. 1-5, 2017.
17. M. A. Schmidt, “Wafer-to-wafer bonding for microstructure formation”, Proceedings of the IEEE, vol. 86, no. 8, pp. 1575-1585, 1998.
18. X. Han, W. Fu, C.-L. Zou, L. Jiang and H. X. Tang, “Microwave-optical quantum frequency conversion”, Optica, vol. 8, no. 8, pp. 1050-1064, 2021.
19. W. Hease, A. Rueda, R. Sahu, M. Wulf, G. Arnold, H. G. Schwefel, et al., “Bidirectional electro-optic wavelength conversion in the quantum ground state”, PRX Quantum, vol. 1, no. 2, pp. 020315, 2020.
20. D. R. W. Yost et al., Solid-state qubits integrated with superconducting through-silicon vias, npj Quantum Information (2020) 59
21. Mirhosseini, Mohammad, et al. “Superconducting qubit to optical photon transduction.” Nature 588.7839 (2020): 599-603.
22. Keller, Andrew J., et al. “Superconducting qubits on silicon substrates for quantum device integration.” arXiv preprint arXiv: 1703.10195 (2017).
23. Nakamura, Yasunobu, et al. “Superconducting qubits consisting of epitaxially grown NbN/AlN/NbN Josephson junctions.” Applied Physics Letters 99.21 (2011): 212502.
24. B. Li, C. P. Ho and C. Lee, “Tunable autler-townes splitting observation in coupled whispering gallery mode resonators”, IEEE Photonics Journal, vol. 8, no. 5, pp. 1-10, 2016.
25. A. Rueda, F. Sedlmeir, M. C. Collodo, U. Vogl, B. Stiller, G. Schunk, D. V. Strekalov, C. Marquardt, J. M. Fink, O. Painter et al., “Efficient microwave to optical photon conversion: an electro-optical realization”, Optica, vol. 3, no. 6, pp. 597-604, 2016.
26. L. T. Guan, L. H. Yu, J. M. Chinq, E. W. L. Ching, C. S. Choong, L. S. Thor, et al., “Silicon optical electrical interposer-fiber to the chip”, 2019 IEEE 21st Electronics Packaging Technology Conference (EPTC), pp. 34-39, 2019.
27. Y. Bian, A. Jacob, A. Thomas, B. Peng, M. Rakowski, W. S. Lee, et al., “Light manipulation in a monolithic silicon photonics platform leveraging 3d coupling and decoupling” in Frontiers in Optics, Optical Society of America, pp. FTu6E-3, 2020.
28. O. A. J. Gordillo, S. Chaitanya, Y.-C. Chang, U. D. Dave, A. Mohanty and M. Lipson, “Plug-and-play fiber to waveguide connector”, Optics express, vol. 27, no. 15, pp. 20 305-20 310, 2019.
29. T. Carmon, S. Y. Wang, E. P. Ostby and K. J. Vahala, “Wavelength-independent coupler from fiber to an on-chip cavity demonstrated over an 850 nm span”, Optics express, vol. 15, no. 12, pp. 7677-7681, 2007.
30. M. Davanço and K. Srinivasan, “Efficient spectroscopy of single embedded emitters using optical fiber taper waveguides”, Optics express, vol. 17, no. 13, pp. 10 542-10 563, 2009.
31. A. W. Schell, H. Takashima, T. T. Tran, I. Aharonovich and S. Takeuchi, “Coupling quantum emitters in 2d materials with tapered fibers”, ACS Photonics, vol. 4, no. 4, pp. 761-767, 2017.
32. S. Khan, S. M. Buckley, J. Chiles, R. P. Mirin, S. W. Nam and J. M. Shainline, “Low-loss high-bandwidth fiber-to-chip coupling using capped adiabatic tapered fibers”, APL Photonics, vol. 5, no. 5, pp. 056101, 2020.
33. R. Marchetti, C. Lacava, L. Carroll, K. Gradkowski and P. Minzioni, “Coupling strategies for silicon photonics integrated chips”, Photonics Research, vol. 7, no. 2, pp. 201-239, 2019.
34. A. Mahoney, J. Colless, S. Pauka, J. Hornibrook, J. Watson, G. Gardner, et al., “On-chip microwave quantum hall circulator”, Physical Review X, vol. 7, no. 1, pp. 011007, 2017.
35. L. Martinez, G. Qiu, G. Carosi, K. Wang, J. DuBois and D. Qu, “Nonreciprocal microwave devices with a topological material”, Bulletin of the American Physical Society, 2022.
36. D.-R. W. Yost, M. E. Schwartz, J. Mallek, D. Rosenberg, C. Stull, J. L. Yoder, G. Calusine, M. Cook, R. Das, A. L. Day et al., “Solid-state qubits integrated with superconducting through-silicon vias”, npj Quantum Information, vol. 6, no. 1, pp. 1-7, 2020.
37 R. N. Das, J. Yoder, D. Rosenberg, D. Kim, D. Yost, J. Mallek, et al., “Cryogenic qubit integration for quantum computing”, 2018 IEEE 68th Electronic Components and Technology Conference (ECTC), pp. 504-514, 2018.
38. B. Lienhard, J. Braumüller, W. Woods, D. Rosenberg, G. Calusine, S. Weber, A. Vepsäläinen, K. O'Brien, T. P. Orlando, S. Gustavsson et al., “Microwave packaging for superconducting qubits”, 2019 IEEE MTT-S International Microwave Symposium (IMS), pp. 275-278, 2019.
39. Fan, Linran, et al. “Superconducting cavity electro-optics: a platform for coherent photon conversion between superconducting and photonic circuits.” Science advances 4.8 (2018): eaar4994.
40. Brecht, T. et al. Multilayer microwave integrated quantum circuits for scalable quantum computing. npj Quantum Inf. 2, 16002 (2016).

What is claimed is:

1. A heterogeneous quantum device comprising:
an interposer;
a qubit sources disposed over the interposer; and
an electro-optic quantum transducer disposed over the interposer, the electro-optic quantum transducer being a frequency converter that converts microwave frequency to optical frequency coupled to the qubit sources by superconducting capacitive or inductive coupling.

2. The heterogeneous quantum device of claim 1 including a first chip that includes the qubit sources.

3. The heterogeneous quantum device of claim 1 wherein the qubit sources are monolithically fabricated on a top face the interposer.

4. The heterogeneous quantum device of claim 1 wherein the qubit sources are included in a first chip disposed over a top face of the interposer.

5. The heterogeneous quantum device of claim 1 wherein a second chip includes the electro-optic quantum transducer.

6. The heterogeneous quantum device of claim 5 wherein the qubit sources is coupled to the electro-optic quantum transducer by in-plane inter-chip inductive coupling of microwave field between the qubit sources and the electro-optic quantum transducer.

7. The heterogeneous quantum device of claim 5 wherein the qubit sources is coupled to the electro-optic quantum transducer by vertical inter-chip inductive coupling of microwave field between the qubit sources and the electro-optic quantum transducer.

8. The heterogeneous quantum device of claim 7 wherein a first chip including the qubit sources is flip bonded to the interposer.

9. The heterogeneous quantum device of claim 1 wherein electro-optic quantum transducer includes microwave resonator.

10. The heterogeneous quantum device of claim 1 wherein a microwave resonator formed by aligning capacitive electrodes and resonator cavities.

11. The heterogeneous quantum device of claim 10 wherein the capacitive electrodes are disposed on a first chip that includes the qubit sources.

12. The heterogeneous quantum device of claim 1 wherein the qubit sources are biased with electrodes electrically communicating with circuitry on a bottom face of the interposer by vias extending through the interposer.

13. The heterogeneous quantum device of claim 1 edge couplers in optical communication with electro-optic quantum transducer.

14. A heterogeneous quantum device comprising:
a plurality of quantum sources;
a plurality of quantum frequency converters;
a plurality of quantum sensors; and
a plurality of quantum memory devices interconnected through electrical or photonics multilevel interconnects on the same interposer platform.

15. The heterogeneous quantum device of claim 14 wherein the plurality of quantum sources are selected from the group consisting of superconducting Josephson Junction qubit, single photon quantum dot qubits, trapped ion qubits, NV center qubits, and combinations thereof.

16. The heterogeneous quantum device of claim 14 wherein the plurality of quantum frequency converters are selected from the group consisting of opto-electromechanical, piezo-opto-mechanical, opto-mechanical, electro-optical, optomagnonics, and combinations thereof.

17. A heterogeneous quantum device comprising:
an interposer;
a superconducting qubit source;
superconducting microwave resonators coupled to the superconducting qubit source by superconducting capacitive or inductive coupling
a microwave to optical transducer for optical photon conversion; and
edge couplers in optical communication with the optical transducer.

18. A heterogeneous quantum device comprising:
an interposer defining a plurality of through silicon vias therethrough, the interposer having a top face and a bottom face;
a top metal layer disposed over the top face;
a qubit circulator positioned on the top face of the interposer;
a transducer chip disposed over the top face of the interposer, the transducer chip including a microwave resonator, an optical microdisk resonator cavity, optical waveguides and an edge coupler, the edge coupler configured to attach the optical waveguides to an input/output fiber;
a superconducting qubit chip disposed over the top face of the interposer, the superconducting qubit chip including qubit sources;
microwave circuits positioned on the top face of the interposer; and
a superconducting redistribution module disposed over the bottom face of the interposer.

19. The heterogeneous quantum device of claim 18 wherein the superconducting qubit chip is flip chip bonded to the interposer.

20. The heterogeneous quantum device of claim 18 wherein the interposer is composed of silicon or sapphire.
